(19) United States
(12) Patent Application Publication
(10) Pub. No.: US 2023/0087208 A1
(43) Pub. Date: Mar. 23, 2023

(54) METHOD FOR EXTRACTING INSTRUCTIONS FOR MONITORING AND/OR CONTROLLING A CHEMICAL PLANT FROM UNSTRUCTURED DATA

(71) Applicant: BASF SE, Ludwigshafen am Rhein (DE)

(72) Inventors: Pavan Kumar RAVINUTALA, Mannheim (DE); Andreas GYPSER, Mannheim (DE)

(21) Appl. No.: 17/798,906

(22) PCT Filed: Feb. 9, 2021
(86) PCT No.: PCT/EP2021/053030

§ 371 Date: Aug. 11, 2022

(30) Foreign Application Priority Data
Feb. 14, 2020 (EP) 20157340.9

(51) Int. Cl. G06F 18/2413; G06F 18/40

(52) U.S. Cl. CPC G06F 18/2413; G06F 18/40; G05B 2219/33034

(57) ABSTRACT

The present invention is in the field of computer-implemented methods for monitoring or controlling a chemical plant. It relates to a computer-implemented method for monitoring and/or controlling a chemical plant comprising (a1) providing unstructured data containing instructions for monitoring and/or controlling a chemical plant, (a2) providing information about the chemical plant at least including information of the geographical location of the plant or the compound handled in the plant through an interface, (b1) providing the unstructured data and the information about the chemical plant to a model suitable for extracting the instructions from the structured data, (b2) obtaining from the model instruction together with metadata including the applicability of the instruction related to at least one of time period, a geographical scope, or the compounds to be handled in the plant, and (c) outputting the instructions received from the model.

The present invention is in the field of computer-implemented methods for monitoring or controlling a chemical plant.

Operating a chemical plant requires a lot of action in order to keep a high level of safety, health of people working in the plant and environmental protection. For example, it is required to monitor emissions into the air and observe different maintenance intervals for each part of the plant. A huge number of such regulations exist. Legal regulations are particularly complex as there are EU regulations, country-specific laws, state-specific laws, county-specific rules, company-specific rules, plant specific regulations or contracts. Going through all these regulations takes a lot of time for the plant operator and it is likely that some action items are missed. Also, if regulations change, a timely reaction to such changes is difficult to do in practice. Therefore, it would be advantageous if a system existed which can automize these tasks. However, this is a fairly difficult task as regulations are mostly unstructured data in the form of human-readable text.

WO 2017/129 636 A1 discloses a method of automatically determining a risk of a patent infringement in a chemical plant. However, this concept cannot easily be transferred to said problem as a risk does not give a direct information to the plant operator what to do.

S. Seppälä et al. disclose in the Proceedings of the 1^{st} Workshop on Technologies for Regulatory Compliance (http://ceur-ws.org/Vol-2049/08paper.pdf) a system which converts complex rules in text form into a logical graph. However, creating a relationship amongst words requires inputting predefined relationship which takes a lot of effort. In addition, the system cannot be easily used with input in different languages.

E. Zamora at al. disclose in the Journal of Chemical Information and Modeling volume 24 (1984) page 176-188 a method for extraction of chemical reaction information from primary journal text. However, this information is only stored into a database, but not transformed into instructions suitable for monitoring and/or controlling a chemical plant.

WO 2019/023 982 A1 discloses a database to store data of an industrial operation obtained from various sources including unstructured data. However, no instructions for monitoring and/or controlling a chemical plant are generated from the database.

US 2008/0 040 298 A1 discloses a method to convert unstructured data related to chemical reactions into structured data to be stored in a structured database. However, no instructions suitable for monitoring and/or controlling a chemical plant are generated.

It was therefore the object of the present invention to provide a method for monitoring or controlling a chemical plant which is fast, reliable, and easy to use in order to increase the operational safety and to minimize the impact on the environment. The method should be flexible so it can easily be adapted to new requirements and quickly provide the necessary action, reliably excluding anything not relevant in a particular situation to unburden the operating personnel.

These objects were achieved by a computer-implemented method for monitoring and/or controlling a chemical plant comprising

(a1) providing unstructured data containing instructions for monitoring and/or controlling a chemical plant,
(a2) providing information about the chemical plant at least including information of the geographical location of the plant or the compound handled in the plant through an interface,
(b1) providing the unstructured data and the information about the chemical plant to a model suitable for extracting the instructions from the unstructured data,
(b2) obtaining from the model instruction together with metadata including the applicability of the instruction related to at least one of time period, a geographical scope, or the compounds to be handled in the plant, and
(c) outputting the instructions received from the model.

The present invention further relates to a non-transitory computer readable data medium storing a computer program including instructions for executing steps of the method according to any of the preceding claims.

The present invention further relates to the use of the instructions obtained in any of the preceding claims for monitoring and/or controlling a chemical plant.

The present invention further relates to a production monitoring and/or control system for monitoring and/or controlling a chemical plant comprising

(a) an input unit configured to receive unstructured data containing instructions for monitoring and/or controlling a chemical plant, and configured to receive information about the chemical plant including information of the geographical location of the plant or the compound handled in the plant,
(b) a processing unit configured to providing the unstructured data and the information about the chemical plant to a model suitable for extracting the instructions together with metadata including the applicability of the instruction related to at least one of time period, a geographical scope, or the compounds to be handled in the plant from the unstructured data, and
(c) an output unit configured to output the instructions received from the model.

Preferred embodiments of the present invention can be found in the description and the claims. Combinations of different embodiments fall within the scope of the present invention.

### BRIEF DESCRIPTION OF THE FIGURES

FIG. 1 shows a potential implementation of the invention.

FIG. 2 shows another potential implementation of the invention.

The present invention relates to a method of monitoring and/or controlling a chemical plant. Monitoring generally means the observation and recording of any state of operation of the chemical plant. The state of operation includes internal parameters, i.e. those parameters which are solely relevant within the plant such as reactor temperature, pressure, electricity consumption, input or output material flows, rotational speeds of stirrers, states of valves, concentrations of vapors in the air within the plant, number of people inside the plant. The state of operation also includes external parameters, i.e. parameters which relate to any exchange with the environment of the plant, such as emission of chemical vapors, heat, sound, vibrations, light. Recording can mean storing the raw data onto a permanent data storage device or preparing documents in a format which are required by the company or by authorities.

Controlling generally means taking any actions to change the state of operation of the chemical plant. The actions can be direct, for example by changing the state of a valve, changing the temperature by additional heating or increasing the cooling. The actions can also be indirect, for example by prompting an operator to take actions, for example exchanging a filter or adjusting throughput.

A chemical plant is any facility which runs chemical reactions to produce chemical compounds, produces formulations by blending chemical compounds, increases the purity of a chemical compound, brings chemical compounds in a different form, or packages chemical compounds or formulations containing chemical compounds. In many cases, a chemical plant accommodates more than one of these activities. Examples for chemical plants include oil refineries; petrochemical plants like steam crackers, ethylene oxide factories, carbon monoxide factories, methanol factories; intermediate chemical plants like plants producing acrylic acid, toluenediisocyanate, tetrahydrofuran; factories producing inorganics such as sulfuric acid, chlorine or iron chloride; factories producing pharmaceuticals or agrochemicals; factories producing food and feed such as aroma chemicals, formulations for nutrition; factories for home and personal care chemicals and formulations; factories producing polymers such as polyethylene, polystyrene, or polyethylene terephthalate; factories producing dispersions; factories producing pigments; factories producing paints and lacquers; factories which increase the purity of compounds for example for the use in analytics, pharmaceuticals, nutrition or microchip production.

The method according to the present invention comprises (a1) providing unstructured data containing instructions for monitoring and/or controlling a chemical plant. Unstructured data is as commonly understood data which either has no pre-defined data model or is not organized in a pre-defined manner. Preferably, the unstructured data is in a format containing characters, for example ASCII code. Preferably, the unstructured data is human-readable. Examples for suitable formats are txt, pdf, html, xml, docx, rtf, odt, postscript, LaTeX, dvi, eml. If the unstructured data is only available in a format not containing characters, for example as a paper-scan bitmap, the data is preferably pre-processed in order to convert it into unstructured data containing characters, in particular into one of the preferred data formats. Various techniques are available such as optical character recognition (OCR). If the unstructured data is available as a collection of various formats, it is preferable to convert them into the same format.

The unstructured data can originate from various sources including technical data sheets, manuals, plans, shipping notes, laws, directives, guidelines, scientific articles, reports. Preferably, the unstructured data originates from more than one source, for example at least two, at least three or at least four. The unstructured data typically originates from multiple different pieces from a source, for example from multiple technical data sheets or from multiple laws. Technical data sheets may for example contain instructions to replace filters if emission values exceed a certain threshold, or to renew lubrication if certain vibrations occur. Manuals may contain instructions on what to do if a valve gets blocked. Legal texts like laws, directives and guidelines are often related to health and safety at work, environmental protection or resource management. They may contain the obligation to record the concentration of certain compounds in the air or reduce the emission of warm water into a river under hot weather conditions. Scientific articles or reports may contain instructions to optimize operation parameters in order to increase product yield or reduce wear of the equipment.

The unstructured data contains instructions. These instructions are typically human-readable. The instructions can be direct or indirect. An example for a direct instruction is to measure and record the temperature of exhaust water. An example for an indirect instruction is to use appropriate care when handling waste. Indirect instructions often have to be combined with direct instructions from other data sources, in the previous example this could be a directive for waste handling. The instructions can be in one language or in different languages, such as English, German, French, Spanish, Portuguese, Chinese, Japanese, Korean, Russian, or Arabian.

In many cases, the unstructured data contains many instructions as well as further information which does not qualify as an instruction. This may even be the case if the unstructured data originates from a single source. A typical example is a manual for a plant which can contain hundreds of pages. It is therefore preferable to parse the unstructured data prior to providing the unstructured data to the model. In this way, smaller parts which most likely do not contain more than one instruction each are obtained. At the same time, data can be removed which obviously does not contain any instructions, for example formatting commands. In a simple example, a sentence or a paragraph may be such a smaller part. However, more sophisticated methods are available which can recognize logical units. Various libraries are available to perform such parsing, for example PDFMiner.

The method according to the present invention comprises (a2) providing information about the chemical plant at least including information of the geographical location of the plant or the compound handled in the plant through an interface. The geographical location may include GPS coordinates, the country and/or state the plant is located in, the distance to waters like rivers, lakes or the sea, or the altitude. Information about the compound handled in the plant may comprise the chemical structure of the compound, its amount used per time, for example per month or per year, or the amount present at the plant a certain time, for example in a storage facility. Preferably, the information about the compound comprises the information if the compound is used as reagent, intermediate or as product.

The method according to the present invention comprises (b1) providing the unstructured data and the information about the chemical plant to a model suitable for extracting the instructions from the unstructured data. The model is preferably a data-driven model. A data-driven model is a trained mathematical model which is parametrized according to a training data to input unstructured data and output structured data, i.e. in this case the instructions for monitoring and/or controlling a chemical plant. The data-driven model is preferably a data-driven machine learning model. The data-driven model can be a linear or polynomial regression, a decision tree, a random forest model, a Bayesian network or a neural network, preferably a neural network. Even more preferably, the neural network is a recurrent neural network, in particular a neural network including long short-term memory (LSTM) or gated recurrent units (GRU).

Preferably, the unstructured data is provided to the model in vectorized form. A typical method for vectorizing the unstructured data is term frequency-inverse document frequency (tf-idf).

Even higher accuracy can be achieved using more advanced techniques for vectorizing the unstructured data, in particular continuous bag-of-words (CBOVV) or continuous skip-gram both of which are available in the library Word2vec.

The model may have been trained with historical data. Historical data in the context of the present invention refers to data sets including the instructions as unstructured data and associate them with the instruction in a structured data format. Historical data can be generated either by manually labelling data or by storing user feedback. In the latter case, the pre-trained model extracts instructions from the unstructured data, provides it to a user, whereupon the user gives the feedback on the results. Such feedback can be in the form of a rating from poor to perfect or in the form of corrections to the result. The results with a high rating or corrected results can be used as additional historical data to further train the model.

The more diverse the unstructured data and the more detailed the instructions need to be obtained from the model, the more historical data needs to be available. Quite a lot of historical data may be available if the task of the present invention has been performed for many plants before by hand and the results are stored in a way that they can be retrieved in a systematic fashion. However, many times this will not be the case. The historical data may also be imbalanced or skewed even if a large amount of historical data is available, for example only few data sets exist for a specific parameter or a class related to metadata. Hence, it is advantageous to increase the amount of historical data artificially by oversampling, for example by random oversampling, synthetic minority over-sampling technique (SMOTE), or adaptive synthetic sampling (ADASYN).

The instructions obtained from the model can have any machine-readable format, for example xml, json, yaml. The instructions usually contain pieces of information required for monitoring and/or controlling a chemical plant. The instructions typically contain the subject, i.e. what needs to be monitored or controlled, and an action to be taken on the subject. The instructions can also contain a time information, for example a period until the action has to be taken or a frequency of doing so. The instruction can also contain information about the operator, i.e. who needs to execute the instruction, for example the safety officer or the manager of a plant. As an example, for a filter exchange, an instruction in xml format could be as follows.

```
<instruction>
  <id> 12345 </id>
  <subject> filter </subject>
  <action> exchange </action>
  <frequency> monthly </frequency>
  <meta-material> dust </meta-material>
  <operator> maintenance expert </operator>
</instruction>
```

According to the invention the model is capable of extracting further metadata from the unstructured data in addition to the instructions including at least one of a time period, a geographical scope, or the compounds to be handled in the plant. Instructions may only apply within a certain time period, for example only in wintertime or it is limited for the next few years. Instructions may only apply to plants within a certain geographical area, for example in a country, in a state, in a town, at locations within a certain distance from waters or settlement areas. Instructions may only apply to plants handling certain compounds, for example heavy metals, volatile organic compounds, explosives, or radioactive materials. The metadata can be used to select only those instructions which are relevant for a certain plant. For this reason, for each plant the corresponding information needs to be provided, so the metadata can be matched with the information about the plant. If there is no match, the instruction is removed for this plant.

The model may thus extract instructions and tag them with the information for which plant this instruction is relevant. Preferably, the model can also tag the instruction with the information about which product the instruction relates to. Preferably, the model can also tag the instruction with the information about which person in a particular plant the instruction is relevant for, for example the safety advisor or the maintenance team.

The model may output similar instructions from different parts of the unstructured data. It is possible that the same instruction is output twice or even more times because it was contained in different data sources, for example in a technical data sheet and also in the plant manual. There may be occasions in which two instructions relate to the same state of operation of the plant but require different actions. An example may be that a national law requires the plant to limit its emission of volatile organics into the air to a certain value. At the same time, a company-internal document requires the plant to limit its emission of volatile organics into the air to a different value which may be lower than the former. Therefore, preferably the instructions are grouped into groups, wherein each group contains all instructions relating to the same state of operation of the plant. Even more preferably, the groups are sorted, wherein the most relevant instruction is placed first. Relevance is determined based on the strictest action, for example the lowest emission limit or the shortest time period for a certain action. The rules for determining relevance may be preset or they may be input by a user, for example the plant operator.

The method according to the present invention comprises (c) outputting the instructions received from the model. Outputting can mean writing the instructions on a non-transitory data storage medium, display it on a user interface or transmit it to a control unit which puts the instructions into physical action. Preferably, the instructions are output by displaying it on a user interface. The user interface is preferably adapted to receive from a user, for example the plant operator, a selection, a modification, a prioritization, or a date for execution for each or a group of instructions. The instructions with the associated user input may be stored on a permanent storage medium or transmitted to a control unit.

Preferably, the user interface has a functionality to list the instructions and order them by certain criteria, for example the due date for an instruction. Preferably, the user interface has a functionality to only display those instructions which are ranked highest in their group containing all instructions relating to the same state of operation of the plant. Preferably, the user interface has a functionality to display the instructions in a calendar, wherein each instruction is placed in the calendar according to its due date.

Preferably, the model is adapted to classify the instruction regarding the associated action. The classification may identify actions for monitoring and actions for controlling. For actions related to monitoring the instructions are preferably transmitted to a control unit. The control unit may be connected to sensors which retrieve information about the state of the plant. The control unit may be adapted to pick the data required by the instruction from a respective sensor and store the result accordingly. The control unit may even be adapted to insert the data into a form template. Such a form template may be necessary for company-internal documentation purposes, or it may be submitted to officials such as a regulation authority.

If instructions for monitoring or controlling a chemical plant are transmitted to a control unit, the instructions are usually converted to signals suitable for triggering monitoring or controlling devices. This conversion is often performed in the control unit. However, other processing units can also be employed for the conversion.

Preferably, the output of instructions with metadata if available are stored in a database, preferably in a graph database. The database associates the instructions and metadata with the plant and its information. Preferably, the database associates each instruction with its origin. In this way, it is possible to execute the process according to the present invention on updated versions of sources of the unstructured data. After extraction of new instructions, the old ones can be replaced in the database. Using the association of the replaced instruction with the plants for which the instruction is relevant, each such plant can be informed about the update in a very short period of time. Therefore, preferably, only those instructions are output which are new or have changed with regard to the last output to a particular plant. Alternatively, it is possible to extract from the database instructions which are necessary if something changes in the plant, for example a raw material is replaced by a different one. It is also possible to simulate which actions will be necessary if certain changes are done in one or more than one plants, for example the production of a product is shifted from one plant in one region to a different plant in a different region. It is also conceivable to optimize a chain of production steps spread over different plants by extracting instructions from the database for each scenario and hence obtain the best set of instructions, for example with regard to cost, environmental impact or time required to effect the instructions.

Preferably, the computer-implemented method for monitoring and/or controlling a chemical plant comprises

(a1) providing unstructured data containing instructions for monitoring and/or controlling a chemical plant through an interface,
(a2) providing information about the chemical plant at least including information of the geographical location of the plant or the compound handled in the plant through an interface,
(b1) providing the unstructured data to a model suitable for extracting the instructions from the unstructured data,
(b2) obtaining from the model instruction together with metadata including the applicability of the instruction related to at least one of time period, a geographical scope, or the compounds to be handled in the plant,
(b3) grouping the instructions into groups, wherein each group contains all instructions relating to the same state of operation of the plant,
(c) outputting the instructions received from the model to a user interface, and
(d) receiving user feedback on the instructions usable for further training of the model.

The present invention further relates to a non-transitory computer readable data medium storing a computer program including instructions for executing steps of the method according to the present invention. Computer readable data medium include hard drives, for example on a server, USB storage device, CD, DVD or Blue-ray discs. The computer program may contain all functionalities and data required for execution of the method according to the present invention or it may provide interfaces to have parts of the method processed on remote systems, for example on a cloud system.

The present invention further relates to a production monitoring and/or control system for monitoring and/or controlling material properties of a sample. Unless explicitly described differently hereafter, the description relating to the method including preferred embodiments also applies to the system. The system can be a computing device, for example a computer, tablet, or smartphone. Often the computing device has a network connection in order to communicate with other computing devices, such as servers or a cloud network.

The production monitoring and/or control system according to the present invention comprises (a) an input unit configured to receive unstructured data containing instructions for monitoring and/or controlling a chemical plant. Preferably the input unit comprises an interface, in particular a user interface which allows the user to select unstructured data to be processed, for example from a local or remote storage medium. According to the present invention, the input unit is configured to receive information about the chemical plant including information of the geographical location of the plant or the compound handled in the plant. The input unit may provide predefined options to select from or enable free input. The input may have an interface to a database containing data about the plant or, preferably, multiple plants, in particular all plants of a company or a group of companies. The input unit may be implemented as a webservice or a standalone software package. The input unit may form the presentation or application layer.

The production monitoring and/or control system according to the present invention comprises (b) a processing unit configured to providing the unstructured data and the information about the chemical plant to a model suitable for extracting the instructions together with metadata including the applicability of the instruction related to at least one of time period, a geographical scope, or the compounds to be handled in the plant from the unstructured data. The processing unit may be a local processing unit comprising a central processing unit (CPU) and/or a graphics processing units (GPU) and/or an application specific integrated circuit (ASIC) and/or a tensor processing unit (TPU) and/or a field-programmable gate array (FPGA). The processing unit may also be an interface to a remote computer system such as a cloud service.

The production monitoring and/or control system according to the present invention comprises (c) an output unit configured to output the instructions received from the model. The output unit may be implemented as a webservice or a standalone software package. The output unit may form the presentation or application layer. Preferably the output unit comprises an interface for outputting the instructions received from the model, in particular a user interface which is configured to display the instructions for the plant. The user may then take the necessary action, for example adjust production parameters or collect sensor data. Preferably, the user interface is configured to receive feedback from the user about the instructions which can be used to further train the model. Alternatively, the output unit may include or have an interface to an apparatus which automatically adjusts production parameters or collects sensor data. Preferably, the output unit has an interface to a database to store the instructions in the database, in particular a graph database. On another run of the production and/or control system, the database can be used to select those instructions which are new or have changed with regard to the last run.

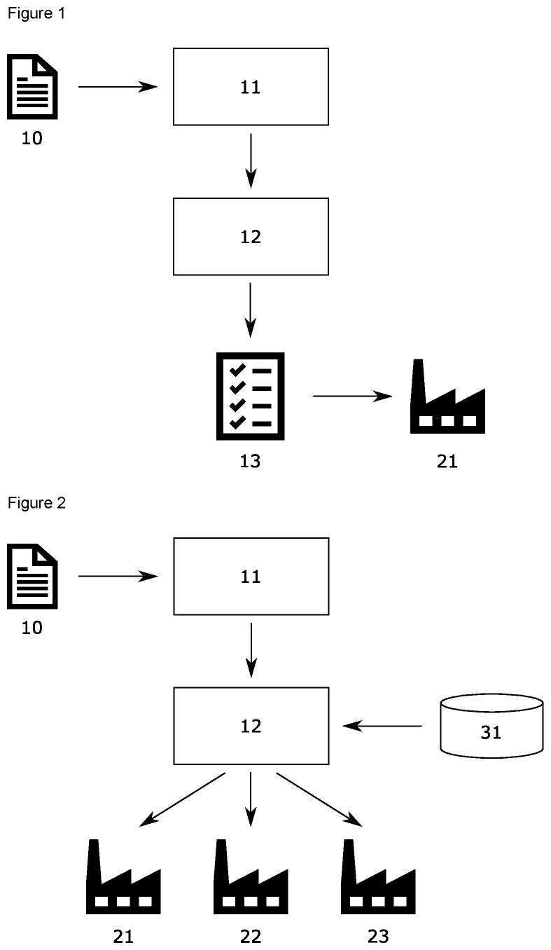

There are several ways of implementing the present invention. One is depicted in FIG. 1. Unstructured data (10) which may or may not be filtered according to its relevance for a certain plant is provided to a processing unit (11). This processing unit provides the unstructured data to a data-driven model which has been trained on historical data. The processing unit obtains from the model instructions which may or may not be grouped, wherein each group contains all instructions relating to the same state of operation of the plant. The instructions are provided to an output unit (12) which outputs the instructions, for example by a user interface displaying a list ordered by due date (13). Each instruction may result in an action in the chemical plant (21), either automatically be a control unit or manually, for example by the plant operator.

An alternative implementation is depicted in FIG. 2. Unstructured data (10) is provided to a processing unit (11). This processing unit provides the unstructured data to a data-driven model which has been trained on historical data. The processing unit (11) obtains from the model instructions together with metadata including at least one of a time period, a geographical scope, or the compounds to be handled in the plant. The processing unit (11) provides these data to an output unit (12). The output unit selects the instructions relevant for each of the plants (21, 22, 23) by comparing the metadata with information about each of the plants (21, 22, 23) obtained from a database (31). The database (31) can also contain information about which instructions were already given to the plants (21, 22, 23), so the output unit can select only those instructions, which have not been given to any of the plants (21, 22, 23) or are an updated version. The plant manager of each of the plants (21, 22, 23) can take the required action to monitor and/or control the plant based on the instructions received from the output unit (12).

1.-16. (canceled)

17. A computer-implemented method for monitoring and/or controlling a chemical plant comprising
(a1) providing unstructured data containing instructions for monitoring and/or controlling a chemical plant,
(a2) providing information about the chemical plant at least including information of the geographical location of the plant or the compound handled in the plant through an interface,
(b1) providing the unstructured data and the information about the chemical plant to a model suitable for extracting the instructions from the unstructured data,
(b2) obtaining from the model instruction together with metadata including the applicability of the instruction related to at least one of time period, a geographical scope, or the compounds to be handled in the plant, and
(c) outputting the instructions received from the model.

18. The method according to claim 17, wherein the model is a neural network.

19. The method according to claim 18, wherein the neural network includes long short-term memory.

20. The method according to claim 17, wherein the instructions are output on a user interface.

21. The method according to claim 20, wherein the user interface is adapted to receive a user feedback on the instructions usable for further training of the model.

22. The method according to claim 17, wherein information about the chemical plant at least including information of the geographical location of the plant or the compounds handled in the plant are provided.

23. The method according to claim 17, wherein metadata including the applicability of the instruction related to at least one of time period, a geographical scope, or the compounds handled in the plant are obtained from the model.

24. The method according to claim 17, wherein the instructions obtained from the model are grouped into groups, wherein each group contains all instructions relating to the same state of operation of the plant.

25. The method according to claim 17, wherein only those instructions are output which are new or have changed with regard the last output to a particular plant.

26. A non-transitory computer readable data medium storing a computer program including instructions for executing steps of the method according to claim 17.

27. Use of the instructions obtained in claim 17 for monitoring and/or controlling a chemical plant.

28. A production monitoring and/or control system for monitoring and/or controlling a chemical plant comprising
(a) an input unit configured to receive unstructured data containing instructions for monitoring and/or controlling a chemical plant, and configured to receive information about the chemical plant including information of the geographical location of the plant or the compound handled in the plant,
(b) a processing unit configured to providing the unstructured data and the information about the chemical plant to a model suitable for extracting the instructions together with metadata including the applicability of the instruction related to at least one of time period, a geographical scope, or the compounds to be handled in the plant from the unstructured data, and
(c) an output unit configured to output the instructions received from the model.

29. The production monitoring and/or control system according to claim 27, wherein the input unit comprises an interface to receive unstructured data to be processed and the output unit comprises an interface to output the instructions.

30. The production monitoring and/or control system according to claim 28, wherein the output unit comprises a user interface and the output unit comprises a user interface.

31. The production monitoring and/or control system according to claim 27, wherein the output unit has an interface to a database to store the instructions in the database.

32. The production monitoring and/or control system according to claim 27, wherein the output unit has a user interface configured to receive feedback from the user about the instructions which can be used to further train the model.
